(19) United States
(12) Patent Application Publication
(10) Pub. No.: US 2016/0048638 A1
(43) Pub. Date: Feb. 18, 2016

(54) METHOD FOR TRAINING IN A MEDICAL CODING SYSTEM

(71) Applicant: Nuance Communications, Inc., Burlington, MA (US)

(72) Inventor: Brian Romanowski, Chicago, IL (US)

(21) Appl. No.: 14/459,640

(22) Filed: Aug. 14, 2014

(51) Int. Cl. G06F 19/00; H04L 12/26; G06Q 50/24; H04L 29/08

(52) U.S. Cl. CPC G06F 19/322; H04L 67/10; H04L 43/04; G06Q 50/24

(57) ABSTRACT

A method for use in a medical coding system is provided. The method may include receiving, at a computing device, one or more electronic medical documents and monitoring a medical coding performance associated with the one or more medical documents. The method may further include identifying at least one medical coding training opportunity associated with the medical coding performance and selecting appropriate training material, based upon, at least in part, the at least one identified medical coding training opportunity.

### TECHNICAL FIELD

This disclosure relates generally to a method for medical records processing, to a method for training medical coders associated with a medical coding system.

### BACKGROUND

Medical coders are used to classify medical and health care concepts using one or more classifications. Medical coders may be involved in various cycles of the health care process, including, for example, inpatient, outpatient, general practitioner visits, etc. Given the multitude of different types of medical encounters that may occur, as well as the incredible workloads of these coders, it is often difficult to properly identify training opportunities that may be specific to each medical coder.

### SUMMARY OF DISCLOSURE

In one implementation, a computer-implemented method for use in a medical coding system is provided. The method may include receiving, at a computing device, one or more electronic medical documents and monitoring a medical coding performance associated with the one or more medical documents. The method may further include identifying at least one medical coding training opportunity associated with the medical coding performance and selecting appropriate training material, based upon, at least in part, the at least one identified medical coding training opportunity.

One or more of the following features may be included. In some embodiments, monitoring a medical coding performance may include monitoring an amount of time associated with completing a particular task and/or whether a particular coder has worked on a particular task previously. The method may further include displaying the appropriate training material to an identified medical coder. In some embodiments, selecting may be based upon, at least in part, one or more of the electronic medical documents, current codes, available medical codes, medical coding guidelines, available training materials, a model of a coder's historical performance, previous training, a performance of other medical coders in a similar situation, a measurable cost of training, and any measurable benefit of training. Displaying may include displaying a link to a text, video or audio tutorial associated with the identified medical coder's computing device. The method may further include storing the appropriate training material at one or more computing devices.

In another implementation, a non-transitory computer-readable storage medium is provided. The non-transitory computer-readable storage medium may have stored thereon instructions, which when executed by a processor result in one or more operations. The operations may include receiving, at a computing device, one or more electronic medical documents and monitoring a medical coding performance associated with the one or more medical documents. Operations may further include identifying at least one medical coding training opportunity associated with the medical coding performance and selecting appropriate training material, based upon, at least in part, the at least one identified medical coding training opportunity.

One or more of the following features may be included. In some embodiments, monitoring a medical coding performance may include monitoring an amount of time associated with completing a particular task and/or whether a particular coder has worked on a particular task previously. Operations may further include displaying the appropriate training material to an identified medical coder. In some embodiments, selecting may be based upon, at least in part, one or more of the electronic medical documents, current codes, available medical codes, medical coding guidelines, available training materials, a model of a coder's historical performance, previous training, a performance of other medical coders in a similar situation, a measurable cost of training, and any measurable benefit of training. Displaying may include displaying a link to a text, video or audio tutorial associated with the identified medical coder's computing device. Operations may further include storing the appropriate training material at one or more computing devices.

In another implementation, a system is provided. The system may include one or more processors configured to receive one or more electronic medical documents and monitoring a medical coding performance associated with the one or more medical documents. The one or more processors may be further configured to identify at least one medical coding training opportunity associated with the medical coding performance and select appropriate training material, based upon, at least in part, the at least one identified medical coding training opportunity.

One or more of the following features may be included. In some embodiments, monitoring a medical coding performance may include monitoring an amount of time associated with completing a particular task and/or whether a particular coder has worked on a particular task previously. The one or more processors may be further configured to display the appropriate training material to an identified medical coder. In some embodiments, selecting may be based upon, at least in part, one or more of the electronic medical documents, current codes, available medical codes, medical coding guidelines, available training materials, a model of a coder's historical performance, previous training, a performance of other medical coders in a similar situation, a measurable cost of training, and any measurable benefit of training. Displaying may include displaying a link to a text, video or audio tutorial associated with the identified medical coder's computing device.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an example of a process in accordance with an embodiment of the present disclosure;

FIG. 2 is a flowchart of a process in accordance with an embodiment of the present disclosure;

FIG. 3 is a diagrammatic view of an example of a process in accordance with an embodiment of the present disclosure;

FIG. 4 is a diagrammatic view of an example of a process in accordance with an embodiment of the present disclosure;

FIG. 5 is a diagrammatic view of an example of a process in accordance with an embodiment of the present disclosure;

FIG. 6 is a diagrammatic view of an example of a process in accordance with an embodiment of the present disclosure;

FIG. 7 is a diagrammatic view of an example of a process in accordance with an embodiment of the present disclosure; and

FIG. 8 shows an example of a computer device and a mobile computer device that can be used to implement the filtering process described herein.

Like reference symbols in the various drawings may indicate like elements.

### DETAILED DESCRIPTION

Embodiments of the present disclosure may include a training process 13 configured to identify training opportunities for medical coders. Medical coders require ongoing training to maintain their level of coding accuracy. Periodic training sessions or materials do not address immediate needs and self-motivated learning does not address problems when the coder is not aware of their problem. When a wrong idea takes hold, errors may accumulate until the mistake is discovered.

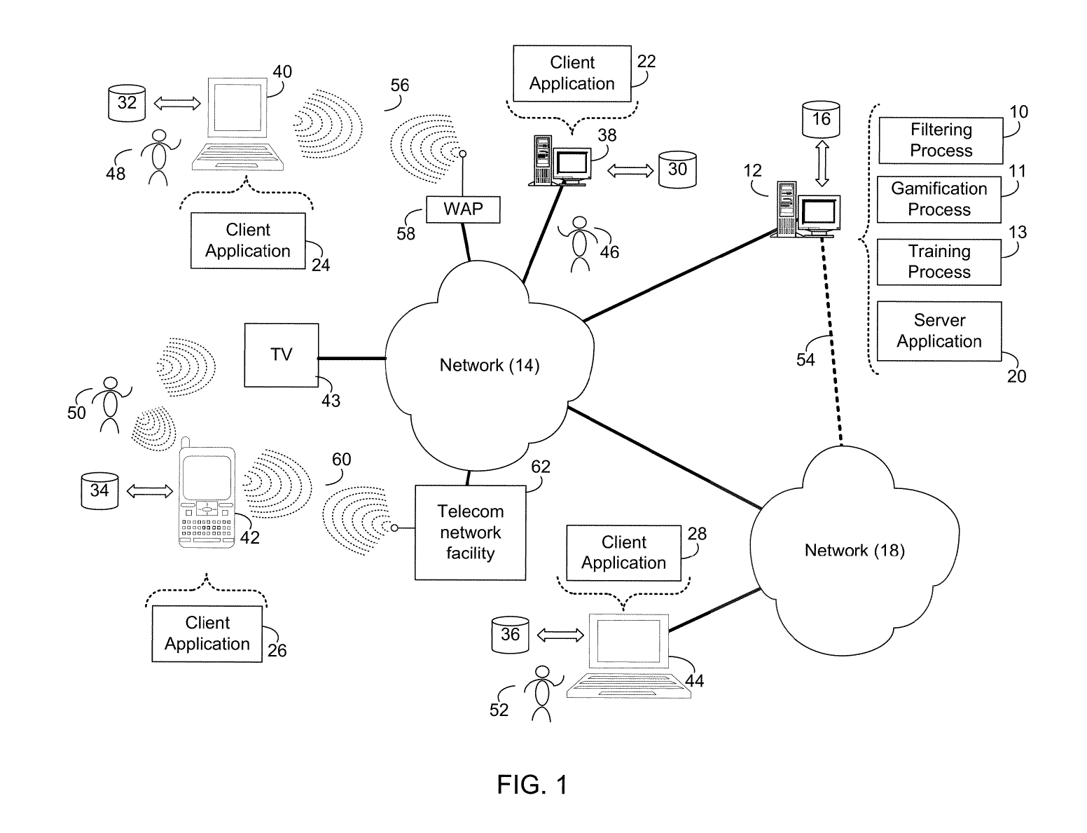

Referring to FIG. 1, a number of processes 10, 11, 13 are provided that may reside on and may be executed by computer 12, which may be connected to network 14 (e.g., the Internet or a local area network). Server application 20 may include some or all of the elements of processes 10, 11, 13 described herein. Examples of computer 12 may include but are not limited to a single server computer, a series of server computers, a single personal computer, a series of personal computers, a mini computer, a mainframe computer, an electronic mail server, a social network server, a text message server, a photo server, a multiprocessor computer, one or more virtual machines running on a computing cloud, and/or a distributed system. The various components of computer 12 may execute one or more operating systems, examples of which may include but are not limited to: Microsoft Windows Server™; Novell Netware™; Redhat Linux™, Unix, or a custom operating system, for example.

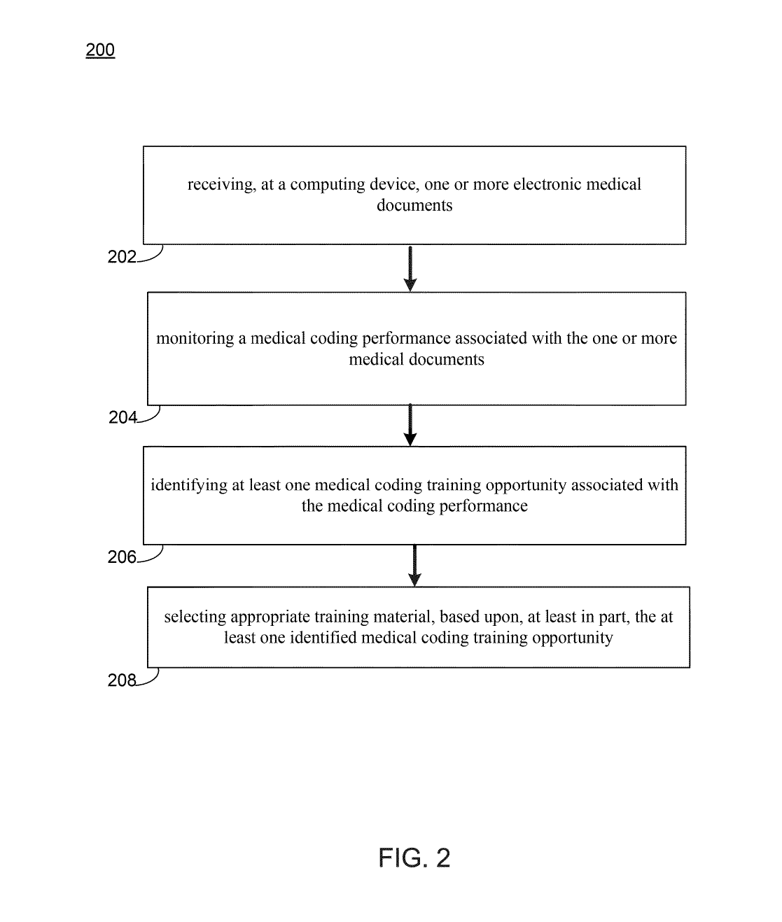

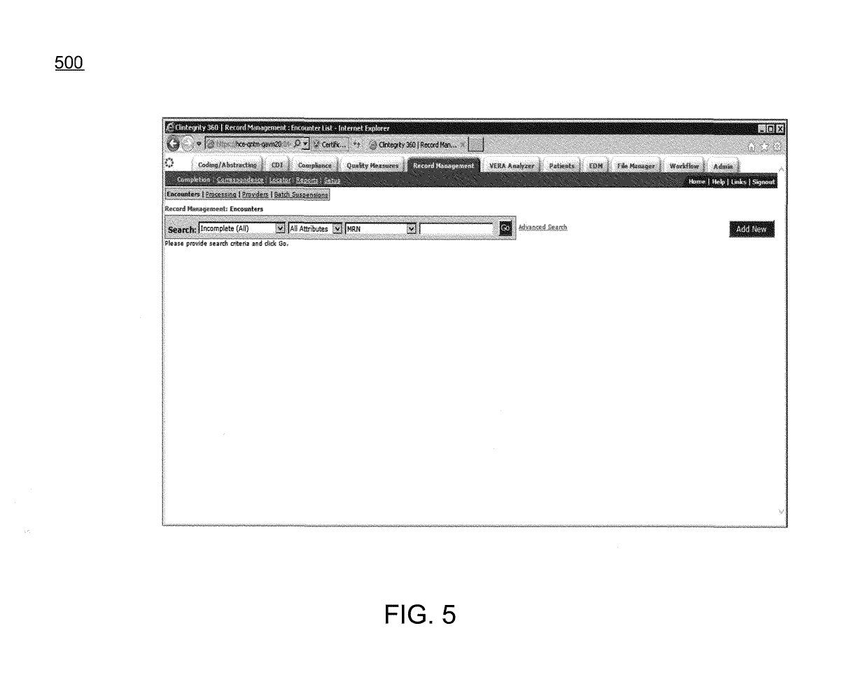

As will be discussed below in greater detail in FIGS. 2-8, training process 13 may include receiving (202), at a computing device, one or more electronic medical documents and monitoring (204) a medical coding performance associated with the one or more medical documents. The method may further include identifying (206) at least one medical coding training opportunity associated with the medical coding performance and selecting (208) appropriate training material, based upon, at least in part, the at least one identified medical coding training opportunity.

The instruction sets and subroutines of processes 10, 11, 13, which may be stored on storage device 16 coupled to computer 12, may be executed by one or more processors (not shown) and one or more memory architectures (not shown) included within computer 12. Storage device 16 may include but is not limited to: a hard disk drive; a flash drive, a tape drive; an optical drive; a RAID array; a random access memory (RAM); and a read-only memory (ROM).

Network 14 may be connected to one or more secondary networks (e.g., network 18), examples of which may include but are not limited to: a local area network; a wide area network; or an intranet, for example.

In some embodiments, processes 10, 11, 13 may be accessed and/or activated via client applications 22, 24, 26, 28. Examples of client applications 22, 24, 26, 28 may include but are not limited to a standard web browser, a customized web browser, or a custom application that can display data to a user. The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively).

Storage devices 30, 32, 34, 36 may include but are not limited to: hard disk drives; flash drives, tape drives; optical drives; RAID arrays; random access memories (RAM); and read-only memories (ROM). Examples of client electronic devices 38, 40, 42, 44 may include, but are not limited to, personal computer 38, laptop computer 40, smart phone 42, television 43, notebook computer 44, a server (not shown), a data-enabled, cellular telephone (not shown), a dedicated network device (not shown), an audio recording device, etc.

One or more of client applications 22, 24, 26, 28 may be configured to effectuate some or all of the functionality of processes 10, 11, 13. Accordingly, processes 10, 11, 13 may be a purely server-side application, a purely client-side application, or a hybrid server-side/client-side application that is cooperatively executed by one or more of client applications 22, 24, 26, 28 and processes 10, 11, 13.

Client electronic devices 38, 40, 42, 44 may each execute an operating system, examples of which may include but are not limited to Apple iOS™, Microsoft Windows™, Android™, Redhat Linux™, or a custom operating system. In some cases, the client electronic device may include audio recording functionality and/or may be an audio recording device. Additionally and/or alternatively, in some embodiments an audio recording device may be in communication with one or more of the client electronic devices.

Users 46, 48, 50, 52 may access computer 12 and processes 10, 11, 13 directly through network 14 or through secondary network 18. Further, computer 12 may be connected to network 14 through secondary network 18, as illustrated with phantom link line 54. In some embodiments, users may access processes 10, 11, 13 through one or more telecommunications network facilities 62.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and smart phones to be interconnected using a short-range wireless connection.

Smart phone 42 is shown wirelessly coupled to network 14 via wireless communication channel 60 established between smart phone 42 and telecommunications network facility 62, which is shown directly coupled to network 14. In some embodiments, smartphone 42 may be an audio recording device or may include audio recording functionality and may enable an end user to record a speech signal. The speech signal may be stored and/or transmitted to any of the devices described herein. For example, transmitted over network 14 to client electronic device 40.

The phrase “telecommunications network facility”, as used herein, may refer to a facility configured to transmit, and/or receive transmissions to/from one or more mobile devices (e.g. cellphones, etc). In the example shown in FIG. 1, telecommunications network facility 62 may allow for communication between any of the computing devices shown in FIG. 1 (e.g., between cellphone 42 and server computing device 12).

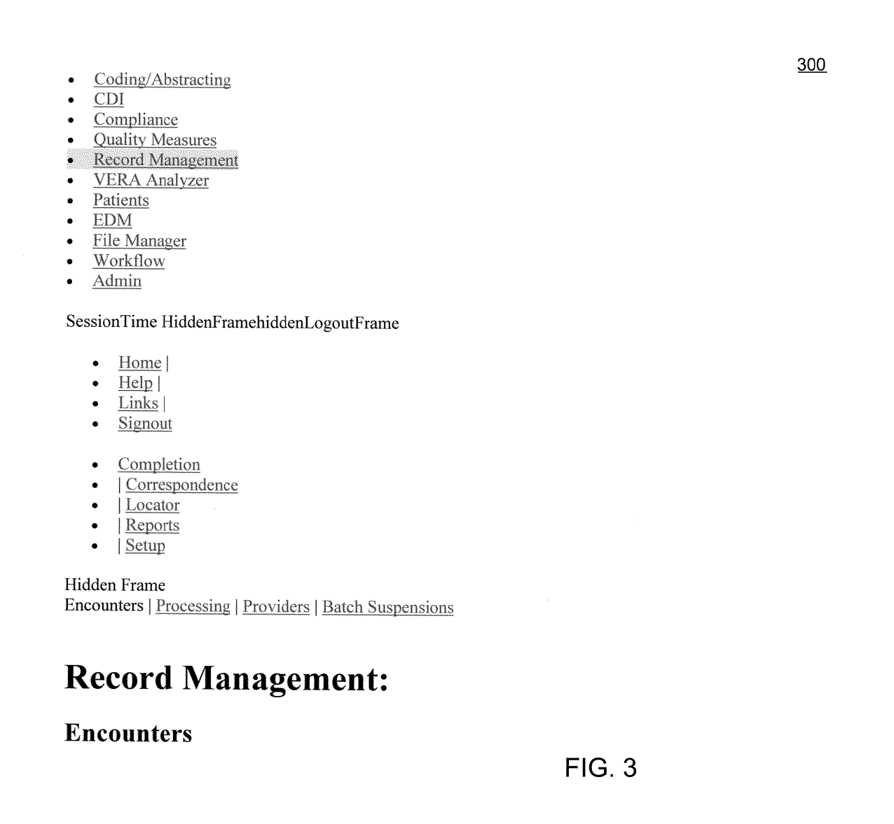

Referring now to FIGS. 3-5, embodiments of an encounter list management application are provided. Encounter list management application 300 may be associated with client application 22 shown in FIG. 1, for example. Encounter List Management issues are generally handled by the administration/management of the coding department. Time and money is often wasted in coding departments because high dollar value and/or complex encounter documentation is often sent to staff that does not have the training or experience to efficiently and expeditiously handle.

Accordingly, filtering process 10 may allow for these types of encounters to be staged and assigned during prime hours to ensure timely completion. Additionally and/or alternatively, filtering process 10 may be configured to allow a manager to monitor and maintain levels within the discharge not final billed (“DNFB”) report, which may be used to measure the financial productivity of the inpatient coding department based on the dollar amount of cases/encounters not coded and/or submitted for billing to the payors. In this way, filtering process 10 may eliminate uneven work distribution by preventing coders from selecting cases that they feel are more desirable.

Accordingly, in operation, filtering process 10 may be configured to receive, at a computing device, one or more electronic medical documents. Referring again to FIG. 1, the electronic medical documents may be received at any suitable device, such as, server computing device 12. The electronic medical documents may be retrievable over a network such as network 14 shown in FIG. 1 and accessible via one or more client electronic devices. In some cases, this may be referred to as a documentation loading process.

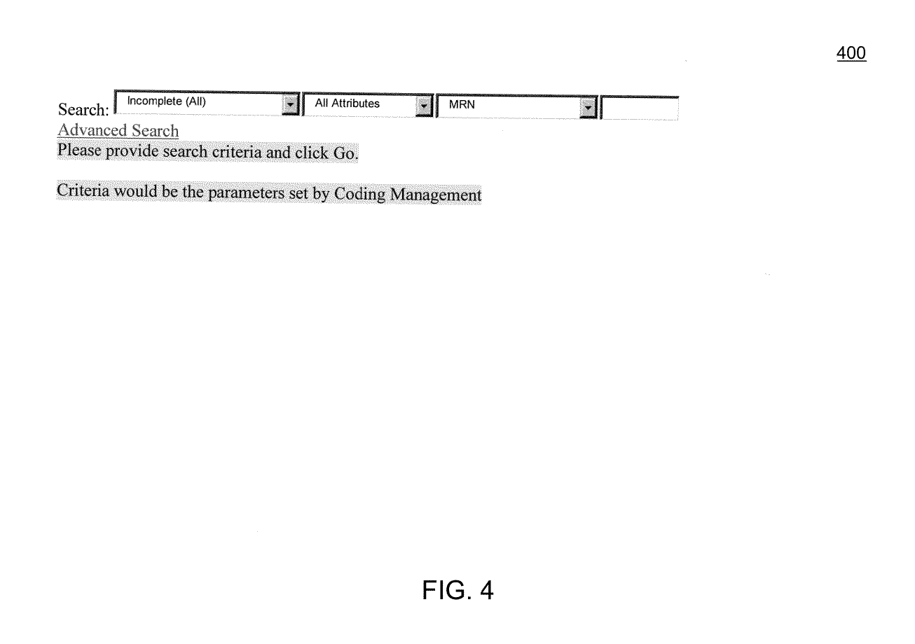

As is shown in FIG. 4, embodiments of filtering process 10 may further include identifying at least one parameter associated with the one or more electronic medical documents. Some parameters may include, but are not limited to, medical area and/or medical specializations achieved via filter/criteria by performing a word or term search, expected complexity of coding task, schedule complex encounters (e.g., based on predetermined, measurable criteria) early in the day to ensure completion and appropriate assignment to staff, time of day related information (e.g., stage encounters in work queues in conjunction with staff schedules (e.g., when coder is going off shift, etc.).

Accordingly, filtering process 10 may be configured to support the manager manipulating/moving encounters into a queue by using, for example, key terms and/or word search criteria, dollar amount, LOS (length of stay), specialty, complexity (e.g., CMI-case mix index), audit cases, training cases, and surgical versus medical. Administrator matches users (coders) to queues or vice versa, etc., all of which may be determined by the administrator. Encounters may then be staged based on coding staff's availability, experience, and training (or lack of). As such, filtering process 10 may allow for segregation of encounters that may require special attention because of factors such as audit criteria, hospital acquired conditions and present on admission criteria as well as any other facility or system requirement necessitating focused review.

Embodiments of filtering process 10 may then filter the one or more medical documents, based upon, at least in part, the at least one parameter. For example, an administrator may filter using the drop-down menus shown in FIG. 4. It should be noted that this particular graphical user interface is provided merely by way of example as any suitable technique may be used to display the aspects of filtering process 10.

At any point in time, filtering process 10 may also connect the one or more medical documents with a particular medical coder. For example, the filtered medical documents may be provided to a medical coder who may then view the medical documents at his/her workstation. Additionally and/or alternatively, the one or more documents may be filtered at the coder's individual workstation. Connecting a medical coder with a particular document may occur using a variety of approaches. For example, in some embodiments, connecting may be performed automatically without user intervention. Additionally and/or alternatively, in some embodiments, connecting may occur after receiving an authorization from an administrator. In some embodiments, connecting may be based upon, at least in part, a workload associated with the medical coder. This may help in ensuring an even workload among medical coders.

In some embodiments, filtering process 10 may be configured to generate a new parameter associated with at least one of the one or more medical documents. For example, an administrator may identify a new parameter that he/she wishes to add to the system. In this way, embodiments of the present disclosure may allow for dynamic updates to the parameters used during the filtering process.

In some embodiments, filtering process 10 may allow for associating one or more medical coders with a particular electronic medical document work queue. Accordingly, filtering process 10 may be configured to route the one or more medical documents to a particular medical coder based upon, at least in part, the association.

Accordingly, filtering process 10 may provide administration/management more control over work flow and assignment. Establish pre-determined filters according to focused audit criteria. Encounters in a “Work Queue” may be manipulated by a system administrator or manager to allow case assignment to coders work queues based on certain criteria. Administrator establishes parameters (Criteria or Filters) for queues that are relevant to how the coding department is organized. In some embodiments, these assignments may occur automatically without requiring input from the manager. For example, the system may automatically determine available bandwidth among coders and assign a document to that coder if they are light on work. Similarly, and as described above, the other parameters may be assessed and documents may be routed automatically based upon any of the other factors included herein (or a combination thereof).

In some embodiments, filtering process 10 may allow for the staging of “training cases” based on specialty. Specialized criteria can be determined by management, or automatically, to meet specific audit needs. As encounters are processed through the system, they may be routed to the queues that match the parameter. The ability to “term search” when encounters are loaded, may also be provided thus further assisting in audit needs.

As discussed above, in some embodiments, filtering process 10 may be configured to allow for the assignment of charts with high dollar charges to coders to reduce the total dollar amount visible on the DNFB report. This report generally indicates the number of dollars not processed and not submitted to the insurance (commercial and government) companies. This report may be used in hospitals as a way to measure the effectiveness of a coding department. It also measures the amount of money tied up in un-submitted claims. Assignment to an experienced coder may be essential as these charts are usually very long length of stay (“LOS”) and more complex than average charts. Management may have control over this and allocate these charts to senior members of the coding staff using the techniques described herein. An automated process would ensure that high dollar charts would always be prioritized.

Accordingly, filtering process 10, in an effort to increase productivity, may allow for the assignment of charts to coders that have proficiency with a certain specialty. Paring specialty charts with specialized coders may help to ensure the accuracy of codes because of a heightened knowledge base. More complex specialties may be completed by coders at the start of their shift. Cost effectively, working on a complex surgical case may be preferred over a normal newborn delivery, for example.

In some embodiments, filtering process 10 may be configured to assign encounters to preferred coders. For example, highly trained coders may handle the more complex charts. Easier charts may be assigned to coders in training or those with little experience in certain areas. Charts that have a potential to be audited or appear on a recovery audit contractor (“RAC”) or pepper list may be coded by someone with auditing, supervisory or validation experience. Potential audit targeted charts may always reviewed by a validator before final submission of codes.

In some embodiments, filtering process 10 may allow for the assignment of “coding ready” charts and may allow the client to define contents (document-type) of chart that would be highly pertinent to the coding of an encounter. An example of this is to filter on surgical cases checking for operative reports. Another example may include filtering on discharge summaries for inpatient charts. In some cases, the system may allow incomplete charts to be staged in a holding pattern pending completion of necessary documents.

Embodiments of the present disclosure may include a gamification process 11. As discussed above, healthcare facilities need to be remunerated for their work with patients. Typically, on discharge from a facility, documents related to the visit are aggregated into a “case” and trained “coders” study the documents and produce a set of billing codes for submission to a payer (usually an insurance company).

Medical coders today may be monitored manually by analyzing their throughput and quality assurance. This subjective and costly process neither supports an incentive structure that can score a coder against many disparate performance measures nor provides a framework to incentivize constant improvement. Currently, there is no objective metric that assigns value to other vital measures such as accuracy or task complexity.

Accordingly, gamification process 11 may be configured to do both in a way that may support not only short-term and subjective measures both also measures that are objective (e.g. computed from data) and long-term (e.g., learning to handle difficult cases or ensuring accuracy). In this way, gamification process 11 may provide a system that may support measuring and evaluating coders using multiple criteria. The gamification process 11 described herein may incentivize medical coders to invest effort now for future rewards.

Accordingly, gamification process 11 may be configured to receive, at a computing device, one or more electronic medical documents. Referring again to FIG. 1, the electronic medical documents may be received at any suitable device, such as, server computing device 12. The electronic medical documents may be retrievable over a network such as network 14 shown in FIG. 1 and accessible via one or more client electronic devices. In some cases, this may be referred to as a documentation loading process.

Once the medical documents have been received by the system, they may be assigned the one or more medical documents with a medical coder. Assignment of medical documents to medical coders may be achieved using any suitable technique such as those discussed above.

In some embodiments, gamification process 11 may be configured to monitor the performance of the medical coder with respect to the one or more medical documents. Monitoring the performance of the medical coder may be performed using a variety of different techniques. For example, monitoring may include determining a complexity associated with a particular task and/or determining a level of accuracy associated with a particular task. Monitoring may also include determining a speed of completion associated with a particular task and/or determining a number of resultant codes associated with the one or more medical documents. In some embodiments, monitoring may include determining a length associated with the one or more medical documents and/or determining a medical specialty associated with the one or more documents.

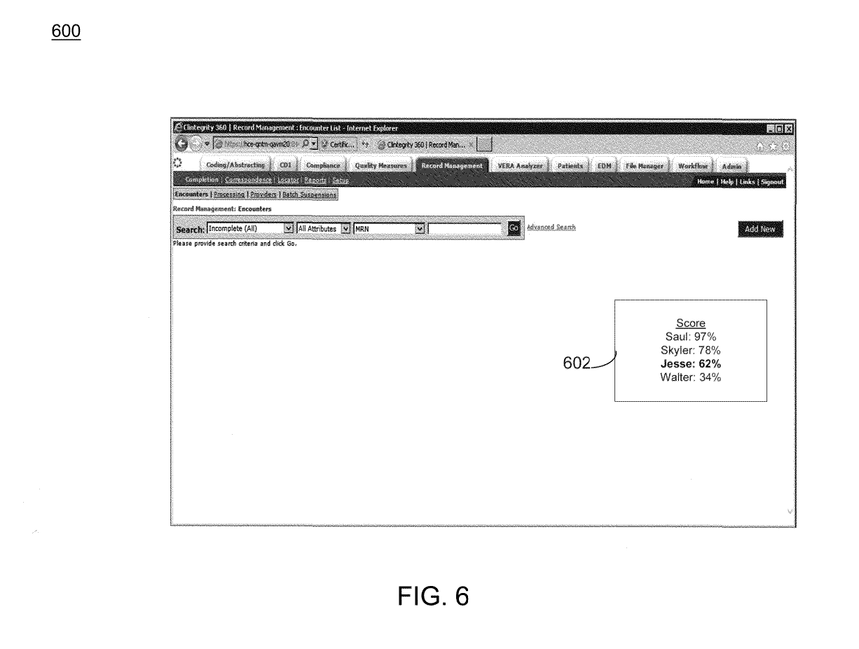

Referring now to FIG. 6, in some embodiments, gamification process 11 may include assigning a score to the medical coder based upon, at least in part, the monitoring. As is shown in the Figure, gamification process 11 may assign the score and subsequently display the score to each user via a graphical user interface 602. In some embodiments, the scores may be displayed to administrators. The identities of some or all of the coders may be blocked if desired.

Accordingly, gamification process 11 may create a framework that will enable an organization to promote excellence across a range of measures. In addition to throughput, gamification process 11 may be configured to support accuracy improvements by, for example, rewarding coders whose work is not denied by insurers or who pass quality assurance spot-checks. In this way, to promote skills acquisition, a coder may be rewarded for passing a graded training assignment.

In some embodiments, a coder may be rewarded for working on difficult cases as measured by length, number of resultant codes, and/or medical specialty. Feedback may be collected both objectively via automatic measurements and/or subjectively via management assessments. In each case, it may be structured to promote competition for excellence in a unified framework.

In some embodiments, gamification process 11 may be configured to notify each coder of their current productivity. For example, when a chart is finished the coder may be notified of daily progress with reference to a daily productivity goal. As shown in FIG. 6, gamification process 11 may also show the coder's productivity in relation to others. In some embodiments, the coder may be able to compare their productivity against expected and average productivity in a graph or table. Additionally and/or alternatively, gamification process 11 may be configured to depict a goal that is appropriate for that coder's level of experience. For example, those below the median may be able to see how far they are from median and those near or above median may be able to see the performance of the top 5, etc.

In some embodiments, gamification process 11 may be configured to show coder accuracy, for example, via a display associated with the coder's computing device. Accuracy may be based upon any number of factors, for example, a rate of encounters returned for quality assurance reasons, etc.

Accordingly, gamification process 11 may allow an organization to reward for each week's top producer, most accurate, most improved, etc. Embodiments disclosed herein may also provide a convenient framework for reporting productivity and accuracy gains. Some examples may include messages provided to the user's workstation (e.g. “Congratulations Sue! You've received 1000 points for being this week's accuracy guru”.) Audio messages may also be provided (e.g., “You processed 10 complete encounters today!<horses in the background> Charge!”). In some embodiments, a message may be provided to all of the coders (e.g., “This week's Lamborghini award goes to Jim who processed 50 encounters!”).

Embodiments of the present disclosure may include a training process 13 configured to identify training opportunities for medical coders. Medical coders require ongoing training to maintain their level of coding accuracy. Periodic training sessions or materials do not address immediate needs and self-motivated learning does not address problems when the coder is not aware of their problem. When a wrong idea takes hold, errors may accumulate until the mistake is discovered.

Existing systems may passively offer access to training materials. For example, an application might offer links to a library of browsable and searchable training resources. This passive access is not helpful when the user is unaware of a problem and is not helpful when the appropriate training material is not discoverable in a large library of potentially-relevant material.

Embodiments of training process 13 may allow for the identification and discovery of training opportunities for the medical coding domain. Training process 13 may provide both continuous and relevant training of coders to maintain a high level of performance.

Accordingly, training process 13 may be configured to receive, at a computing device, one or more electronic medical documents. Referring again to FIG. 1, the electronic medical documents may be received at any suitable device, such as, server computing device 12. The electronic medical documents may be retrievable over a network, such as network 14 shown in FIG. 1, and accessible via one or more client electronic devices. In some cases, this may be referred to as a documentation loading process.

In some embodiments, training process 13 may include monitoring a medical coder's performance associated with the one or more medical documents. A determination of the performance of a particular medical coder may be achieved using a number of suitable techniques such as those described above. For example, monitoring may include monitoring an amount of time associated with completing a particular task and/or whether a particular coder has worked on a particular task previously. This may be compared against an average as calculated from the results of other coders, for example. In some embodiments, monitoring the medical coding performance may be used as one of potentially many features used to estimate future medical coding performance.

Based upon the monitored performance, training process 13 may be configured to identify at least one medical coding training opportunity associated with the medical coding performance and to select appropriate training material. The selection may be based on the at least one identified medical coding training opportunity. The selection of appropriate material may also be based upon the electronic medical documents, current codes, available medical codes, medical coding guidelines, available training materials, a model of a coder's historical performance, previous training, a performance of other medical coders in a similar situation, a measurable cost of training, and any measurable benefit of training. In some embodiments, identifying at least one medical coding training opportunity may include identifying those opportunities associated with expected gains in future medical coding performance. Numerous other parameters may also be considered when selecting appropriate materials for a particular coder.

Accordingly, training process 13 may be configured to support the education of a coder by monitoring their performance, and offering relevant training at appropriate times. In some embodiments, training material may be provided upon a determination of slow performance and possibly on items that the particular coder has not worked upon previously. In some embodiments, training process 13 may determine that interrupting the coder is undesirable at a particular time. For example, a determination may be made that the time is wrong for an interruption, that there is nothing in the library of training materials that is relevant, and the coder or their supervisor may prevent the display of the training alert, etc.

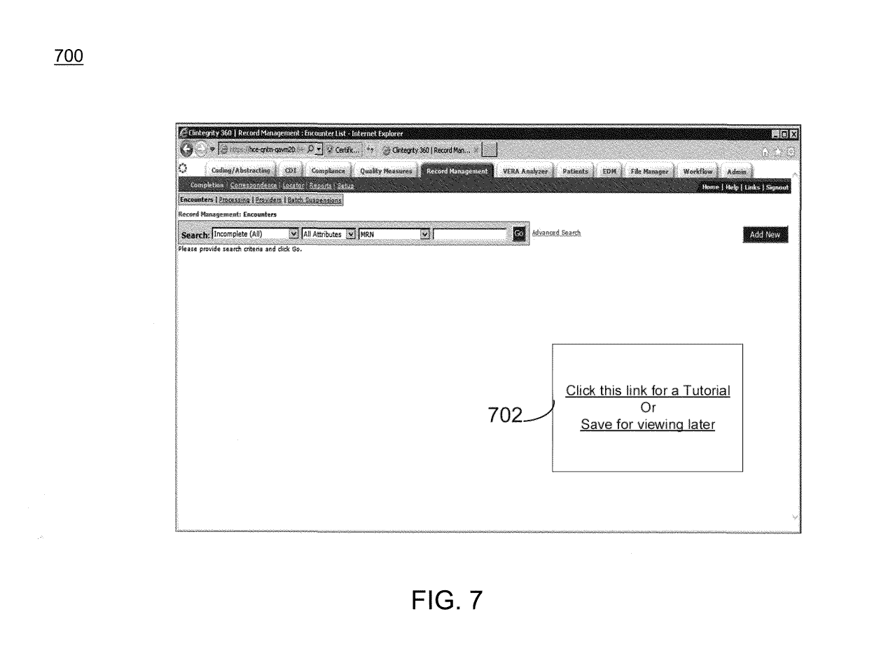

Referring now to FIG. 7, an embodiment consistent with training process 13 is provided. In this particular embodiment, a graphical user interface 702 may be displayed to the identified medical coder wherein the interface provides a link to educational material that may be delivered via a link to an audio, text, or video, for example. In some embodiments, GUI 702 may be provided, during the session and/or placed in a queue for after the session. In some cases, and in the gamification scenario outlined above, watching the video may not have any effect upon the scoring associated with the gamification process. In some embodiments, one or more pop quizzes may be provided to the user to assure people are paying attention (e.g., particularly if this is combined with gamification process). Additionally and/or alternatively, training process 13 may provide text, audio and/or video directly without requiring selection of a link.

Embodiments of training process 13 may allow for the identification of training opportunities and the selection of appropriate training material. In some embodiments, these two parts may be accomplished independently (e.g., first the identification and then the selection of material) or jointly. For example, the joint approach may include determining whether there are sets of training material whose expected value to the institution and the coder would outweigh the costs of training. A statistical model may combine available information and cause the application to show the set of training material expected to give the highest benefit if the expected benefit surpassed some threshold determined by the institution.

In some embodiments, training process 13 may include one or more indicators that may be used to identify a teachable moment and associated training materials. These may include, but are not limited to, the medical documents currently being coded, current codes, available medical codes, medical coding guidelines, available training materials, a model of a coder's historical performance, previous training, the performance of other coders in a similar situation, the measurable cost of training (e.g., time required to consume training materials), and any measurable benefit of training (e.g., the expected increase in reimbursement).

In some embodiments, training process 13 may allow for the user to download the training materials for later use. For example, the user may download a podcast, which may be listened to at a later time. Similarly, videos may be downloaded to the user's phone, for example, or blog posts may be stored for eventual reading.

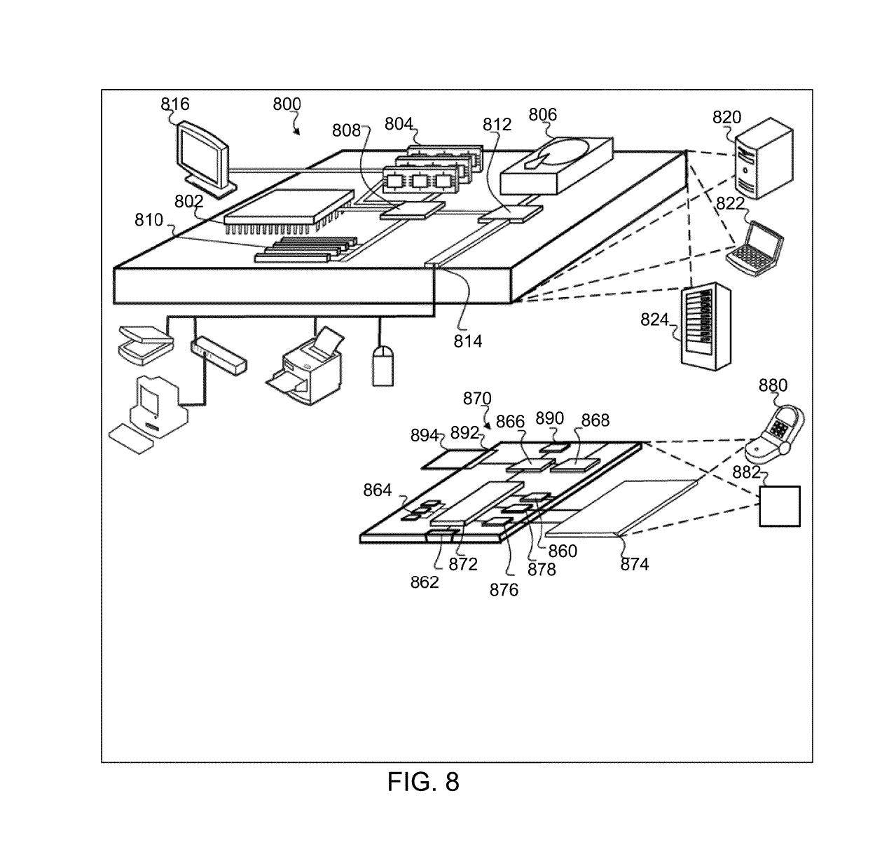

Referring now to FIG. 8, an example of a generic computer device 800 and a generic mobile computer device 870, which may be used with the techniques described herein. Computing device 800 is intended to represent various forms of digital computers, such as tablet computers, laptops, desktops, workstations, personal digital assistants, servers, blade servers, mainframes, and other appropriate computers. In some embodiments, computing device 870 can include various forms of mobile devices, such as personal digital assistants, cellular telephones, smartphones, and other similar computing devices. Computing device 870 and/or computing device 800 may also include other devices, such as televisions with one or more processors embedded therein or attached thereto. The components shown here, their connections and relationships, and their functions, are meant to be exemplary only, and are not meant to limit implementations of the inventions described and/or claimed in this document.

In some embodiments, computing device 800 may include processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, may be interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multiprocessor system).

Memory 804 may store information within the computing device 800. In one implementation, the memory 804 may be a volatile memory unit or units. In another implementation, the memory 804 may be a non-volatile memory unit or units. The memory 804 may also be another form of computer-readable medium, such as a magnetic or optical disk.

Storage device 806 may be capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, memory on processor 802, or a propagated signal.

High speed controller 808 may manage bandwidth-intensive operations for the computing device 800, while the low speed controller 812 may manage lower bandwidth-intensive operations. Such allocation of functions is exemplary only. In one implementation, the high-speed controller 808 may be coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 870. Each of such devices may contain one or more of computing device 800, 870, and an entire system may be made up of multiple computing devices 800, 870 communicating with each other.

Computing device 870 may include a processor 872, memory 864, an input/output device such as a display 874, a communication interface 866, and a transceiver 868, among other components. The device 870 may also be provided with a storage device, such as a microdrive or other device, to provide additional storage. Each of the components 870, 872, 864, 874, 866, and 868, may be interconnected using various buses, and several of the components may be mounted on a common motherboard or in other manners as appropriate.

Processor 872 may execute instructions within the computing device 870, including instructions stored in the memory 864. The processor may be implemented as a chipset of chips that include separate and multiple analog and digital processors. The processor may provide, for example, for coordination of the other components of the device 870, such as control of user interfaces, applications run by device 870, and wireless communication by device 870.

In some embodiments, processor 872 may communicate with a user through control interface 878 and display interface 876 coupled to a display 874. The display 874 may be, for example, a TFT LCD (Thin-Film-Transistor Liquid Crystal Display) or an OLED (Organic Light Emitting Diode) display, or other appropriate display technology. The display interface 876 may comprise appropriate circuitry for driving the display 874 to present graphical and other information to a user. The control interface 878 may receive commands from a user and convert them for submission to the processor 872. In addition, an external interface 862 may be provide in communication with processor 872, so as to enable near area communication of device 870 with other devices. External interface 862 may provide, for example, for wired communication in some implementations, or for wireless communication in other implementations, and multiple interfaces may also be used.

In some embodiments, memory 864 may store information within the computing device 870. The memory 864 can be implemented as one or more of a computer-readable medium or media, a volatile memory unit or units, or a non-volatile memory unit or units. Expansion memory 874 may also be provided and connected to device 870 through expansion interface 872, which may include, for example, a SIMM (Single In Line Memory Module) card interface. Such expansion memory 874 may provide extra storage space for device 870, or may also store applications or other information for device 870. Specifically, expansion memory 874 may include instructions to carry out or supplement the processes described above, and may include secure information also. Thus, for example, expansion memory 874 may be provide as a security module for device 870, and may be programmed with instructions that permit secure use of device 870. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product may contain instructions that, when executed, perform one or more methods, such as those described above. The information carrier may be a computer- or machine-readable medium, such as the memory 864, expansion memory 874, memory on processor 872, or a propagated signal that may be received, for example, over transceiver 868 or external interface 862.

Device 870 may communicate wirelessly through communication interface 866, which may include digital signal processing circuitry where necessary. Communication interface 866 may provide for communications under various modes or protocols, such as GSM voice calls, SMS, EMS, or MMS speech recognition, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 870, which may be used as appropriate by applications running on device 870.

Device 870 may also communicate audibly using audio codec 860, which may receive spoken information from a user and convert it to usable digital information. Audio codec 860 may likewise generate audible sound for a user, such as through a speaker, e.g., in a handset of device 870. Such sound may include sound from voice telephone calls, may include recorded sound (e.g., voice messages, music files, etc.) and may also include sound generated by applications operating on device 870.

Computing device 870 may be implemented in a number of different forms, as shown in the figure. For example, it may be implemented as a cellular telephone 880. It may also be implemented as part of a smartphone 882, personal digital assistant, remote control, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method for use in a medical coding system comprising:
receiving, at a computing device, one or more electronic medical documents;
monitoring a medical coding performance associated with the one or more medical documents;
identifying at least one medical coding training opportunity associated with the medical coding performance; and
selecting appropriate training material, based upon, at least in part, the at least one identified medical coding training opportunity.

2. The method of claim 1, wherein monitoring a medical coding performance includes monitoring an amount of time associated with completing a particular task.

3. The method of claim 1, wherein monitoring a medical coding performance includes monitoring whether a particular coder has worked on a particular task previously.

4. The method of claim 1, further comprising:
displaying the appropriate training material to an identified medical coder.

5. The method of claim 1, wherein selecting is based upon, at least in part, one or more of the electronic medical documents, current codes, available medical codes, medical coding guidelines, available training materials, a model of a coder's historical performance, previous training, a performance of other medical coders in a similar situation, a measurable cost of training, and any measurable benefit of training.

6. The method of claim 4, wherein displaying includes displaying a link to a text, video or audio tutorial associated with the identified medical coder's computing device.

7. The method of claim 4, further comprising:
storing the appropriate training material at one or more computing devices.

8. A non-transitory computer-readable storage medium having stored thereon instructions, which when executed by a processor result in one or more operations, the operations comprising:
receiving, at a computing device, one or more electronic medical documents;
monitoring a medical coding performance associated with the one or more medical documents;
identifying at least one medical coding training opportunity associated with the medical coding performance; and
selecting appropriate training material, based upon, at least in part, the at least one identified medical coding training opportunity.

9. The non-transitory computer-readable storage medium of claim 8, wherein monitoring a medical coding performance includes monitoring an amount of time associated with completing a particular task.

10. The non-transitory computer-readable storage medium of claim 8, wherein monitoring a medical coding performance includes monitoring whether a particular coder has worked on a particular task previously.

11. The non-transitory computer-readable storage medium of claim 8, further comprising:
displaying the appropriate training material to an identified medical coder.

12. The non-transitory computer-readable storage medium of claim 8, wherein selecting is based upon, at least in part, one or more of the electronic medical documents, current codes, available medical codes, medical coding guidelines, available training materials, a model of a coder's historical performance, previous training, a performance of other medical coders in a similar situation, a measurable cost of training, and any measurable benefit of training.

13. The non-transitory computer-readable storage medium of claim 11, wherein displaying includes displaying a link to a text, video or audio tutorial associated with the identified medical coder's computing device.

14. The non-transitory computer-readable storage medium of claim 11, further comprising:
storing the appropriate training material at one or more computing devices.

15. A system for use in a medical coding system comprising:
one or more processors configured to receive one or more electronic medical documents and monitor a medical coding performance associated with the one or more medical documents, the one or more processor further configured to identify at least one medical coding training opportunity associated with the medical coding performance and select appropriate training material, based upon, at least in part, the at least one identified medical coding training opportunity.

16. The system of claim 15, wherein monitoring a medical coding performance includes monitoring an amount of time associated with completing a particular task.

17. The system of claim 15, wherein monitoring a medical coding performance includes monitoring whether a particular coder has worked on a particular task previously.

18. The system of claim 15, wherein selecting is based upon, at least in part, one or more of the electronic medical documents, current codes, available medical codes, medical coding guidelines, available training materials, a model of a coder's historical performance, previous training, a performance of other medical coders in a similar situation, a measurable cost of training, and any measurable benefit of training.

19. The system of claim 15, further comprising:
displaying the appropriate training material to an identified medical coder.

20. The system of claim 19, wherein displaying includes displaying a link to a text, video or audio tutorial associated with the identified medical coder's computing device.
